(19) United States
(12) Patent Application Publication
(10) Pub. No.: US 2025/0365530 A1
(43) Pub. Date: Nov. 27, 2025

(54) SOUND-GENERATING UNIT AND ELECTRONIC DEVICE

(71) Applicant: GOERTEK INC., Weifang (CN)

(72) Inventors: Xiaodong CAI, Weifang (CN); Ye Tian, Weifang (CN); Bobo Li, Weifang (CN)

(21) Appl. No.: 19/298,347

(22) Filed: Aug. 13, 2025

Related U.S. Application Data
(63) Continuation of application No. PCT/CN2025/078434, filed on Feb. 21, 2025.

(30) Foreign Application Priority Data
Apr. 29, 2024 (CN) 202420930891.X

(51) Int. Cl. H04R 1/24; H04R 1/06; H04R 9/02; H04R 9/04; H04R 9/06; H04R 17/00

(52) U.S. Cl. CPC H04R 1/24; H04R 1/06; H04R 9/025; H04R 9/045; H04R 9/063; H04R 17/00; H04R 2400/11

(57) ABSTRACT

The present application discloses a sound-generating unit including a housing, a magnetic circuit system, and a vibration system. A conductive terminal is formed at the housing by injection molding; the magnetic circuit system is provided in the housing, the magnetic circuit system is provided with a bass magnetic gap and a midrange magnetic gap; and a vibration system includes a bass vibration unit, a midrange vibration unit and a treble vibration unit. The midrange vibration unit and the treble vibration unit are provided at a same side of the magnetic circuit system, and the midrange vibration unit is provided around the treble vibration unit. The bass vibration unit is provided at the other side of the magnetic circuit system. The bass vibration unit includes a bass vibration diaphragm and a bass voice coil, and the bass voice coil is provided in the bass magnetic gap.

### CROSS-REFERENCE TO RELATED APPLICATIONS

This application is a continuation application of International Application No. PCT/CN2025/078434, filed on Feb. 21, 2025, which claims priority to Chinese Patent Application No. 202420930891.X, filed on Apr. 29, 2024, the entire contents of which are incorporated herein by reference.

### TECHNICAL FIELD

The present application relates to the technical field of electroacoustic transducers, and in particular to a sound-generating unit and an electronic device applying the sound-generating unit.

### BACKGROUND

In recent years, convenient electronic devices (such as mobile phones, earphones, and computers) have been widely used in people's daily lives. With the rapid development of science and technology, people's requirements for the sound quality of electronic devices are increasing, and the full-frequency and miniaturization of speakers have become mainstream requirements.

In related technologies, the common full-frequency solution is to assemble the bass speaker and treble speaker into one electronic device, but due to the limited space of the electronic device, sizes of these two speakers are greatly restricted, which affects the full-frequency effects of the speakers, resulting in lower performance and making the speakers cannot achieve better sound quality. In addition, the treble unit usually plays a role in the treble performance, and the bass speaker usually plays a role in the midrange performance and the bass performance, so that the bass unit cannot give full play to the low-frequency performance of the bass speaker.

### SUMMARY

The main purpose of the present application is to provide a sound-generating unit and an electronic device, aiming to provide a sound-generating unit capable of realizing full-frequency and miniaturization. The sound-generating unit integrates the bass unit, the midrange unit and the treble unit into one unit, so as to occupy a smaller space and have higher overall space adaptability. On the premise of ensuring the advantages of low-frequency and high-frequency performance, the mid-frequency performance can be fully utilized to achieve full-frequency and miniaturization, thereby improving the performance of the speaker.

To achieve the above purpose, the present application proposes a sound-generating unit, which includes: a housing, a conductive terminal being formed at the housing by injection molding; a magnetic circuit system provided in the housing, the magnetic circuit system being provided with a bass magnetic gap and a midrange magnetic gap; and a vibration system including a bass vibration unit, a midrange vibration unit and a treble vibration unit.

The midrange vibration unit and the treble vibration unit are provided at a same side of the magnetic circuit system, and the midrange vibration unit is provided around the treble vibration unit. The bass vibration unit is provided at the other side of the magnetic circuit system. The bass vibration unit includes a bass vibration diaphragm and a bass voice coil, and the bass voice coil is provided in the bass magnetic gap. The midrange vibration unit includes a midrange vibration diaphragm and a midrange voice coil, and the midrange voice coil is provided in the midrange magnetic gap. The treble vibration unit is a piezoelectric unit.

In an embodiment, the magnetic circuit system includes a first magnetic conductive piece, a center magnet, an edge magnet, a center magnetic conductive piece and an edge magnetic conductive piece; the center magnet and the edge magnet are provided at the first magnetic conductive piece; the center magnetic conductive piece is provided at a side of the center magnet away from the first magnetic conductive piece, and the edge magnetic conductive piece is provided at a side of the edge magnet away from the first magnetic conductive piece; the edge magnetic conductive piece is provided with a sidewall; and the bass magnetic gap is formed between the sidewall and the first magnetic conductive piece, and the midrange magnetic gap is formed between the center magnetic conductive piece and the edge magnetic conductive piece.

In an embodiment, the bass vibration diaphragm includes a bass inner folding ring, a bass outer folding ring and a bass vibration plate; and the bass inner folding ring is connected to the magnetic circuit system, and the bass outer folding ring is connected to the housing.

In an embodiment, a support block is provided at a side of the magnetic circuit system close to the bass vibration unit, and the bass inner folding ring is fixed to the support block.

In an embodiment, the support block is made of magnetic material, and a magnetization direction of the support block is opposite to a magnetization direction of the center magnet; or the support block is made of non-magnetic material.

In an embodiment, the midrange vibration diaphragm includes a midrange inner folding ring, a midrange outer folding ring and a midrange vibration plate; and the midrange inner folding ring is connected to the center magnetic conductive piece, and the midrange outer folding ring is connected to the edge magnetic conductive piece.

In an embodiment, the edge magnetic conductive piece is provided with an outer bracket, and the midrange outer folding ring is fixed to the outer bracket; and the center magnetic conductive piece is provided with an inner bracket, and the midrange inner folding ring is fixed to the inner bracket.

In an embodiment, the treble vibration unit includes a treble vibration plate and a piezoelectric ceramic provided at the treble vibration plate, and an edge of the treble vibration plate is fixed to the inner bracket.

In an embodiment, the inner bracket is provided with a substrate and a surrounding plate provided around a periphery of the substrate; and the treble vibration plate is connected to the surrounding plate, and a treble back cavity is formed between the treble vibration unit and the inner bracket.

In an embodiment, the magnetic circuit system is provided with a through hole, and the through hole communicates the midrange magnetic gap with an external space of the sound-generating unit; the through hole includes a first through hole penetrating the first magnetic conductive piece, a second through hole penetrating the center magnet, and a third through hole penetrating the center magnetic conductive piece; and the first through hole, the second through hole and the third through hole are communicated with each other.

In an embodiment, the housing is provided with a bottom plate, an inside plate and an outside plate; the inside plate is connected to the edge magnetic conductive piece, and the outside plate is connected to the bass outer folding ring; and the bottom plate is provided with a bass sound outlet.

The present application further provides an electronic device including the sound-generating unit as mentioned above.

For the sound-generating unit of the present application, a magnetic circuit system is provided in a housing. A bass magnetic gap and a midrange magnetic gap are provided in the magnetic circuit system. A midrange vibration unit and a treble vibration unit of a vibration system are provided at the same side of the magnetic circuit system, making the midrange vibration unit surround the treble vibration unit. Further, the bass vibration unit is provided at the other side of the magnetic circuit system, so that the bass voice coil of the bass vibration unit is provided in the bass magnetic gap, and the midrange voice coil of the midrange vibration unit is provided in the midrange magnetic gap. The treble vibration unit is the piezoelectric unit. In this way, the bass vibration unit, the midrange vibration unit and the treble vibration unit of the vibration system are integrated into one structure, the magnetic circuit system can be shared, and the Z-axis space of the sound-generating unit can be utilized, thereby realizing a sound-generating unit that is highly integrated with the bass unit, the midrange unit and the treble unit. In this way, the space occupied by the sound-generating unit is smaller, and the space adaptability of the whole machine is higher. Further, the bass vibration unit, the midrange vibration unit and the treble vibration unit of the vibration system play a role in the sound of their respective frequency bands, and the best sound quality experience of the whole machine can be achieved according to the whole machine effect. Thus, under the premise of ensuring the advantages of low-frequency and high-frequency performance, not only the mid-frequency performance can be fully utilized, but also the full-frequency and miniaturization can be realized, and the performance of the sound-generating unit can be effectively improved.

### BRIEF DESCRIPTION OF THE DRAWINGS

To more clearly illustrate technical solutions in the embodiments of the present application or the related art, the following will briefly introduce the drawings that need to be used in the description of the embodiments or the related art. Obviously, the drawings in the following description are only some embodiments of the present application. For those skilled in the art, without creative effort, other drawings can be obtained according to the structures shown in these drawings.

FIG. 1 is a structural schematic diagram of a sound-generating unit according to an embodiment of the present application.

FIG. 2 is a structural schematic diagram of the sound-generating unit according to an embodiment of the present application from another perspective.

FIG. 3 is an exploded schematic diagram of the sound-generating unit according to an embodiment of the present application.

FIG. 4 is a cross-sectional schematic diagram of the sound-generating unit according to an embodiment of the present application.

FIG. 5 is a structural schematic diagram of the sound-generating unit without a bass vibration diaphragm according to an embodiment of the present application.

FIG. 6 is a structural schematic diagram of the sound-generating unit according to another embodiment of the present application.

FIG. 7 is a structural schematic diagram of the sound-generating unit according to another embodiment of the present application from yet another perspective.

FIG. 8 is an exploded schematic diagram of the sound-generating unit according to another embodiment of the present application.

FIG. 9 is a cross-sectional schematic diagram of the sound-generating unit according to another embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in detail below with reference to the accompanying drawings. It is obvious that the embodiments described are only some rather than all of the embodiments of the present application. All other embodiments obtained by those skilled in the art based on the embodiments of the present application without creative efforts shall fall within the protection scope of the present application.

It should be noted that all the directional indications (such as up, down, left, right, front, rear . . . ) in the embodiments of the present application are only used to explain the relative positional relationship, movement, or the like of the components in a certain posture (as shown in the drawings). If the specific posture changes, the directional indication will change accordingly.

In addition, if “and/or” appears throughout the text, it includes three parallel schemes. Taking “A and/or B” as an example, it includes the scheme A, or the scheme B, or the scheme that the scheme A and the scheme B satisfy at the same time.

Besides, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. In addition, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

In recent years, convenient electronic devices (such as mobile phones, earphones, and computers) have been widely used in people's daily lives. With the rapid development of science and technology, people's requirements for the sound quality of electronic devices are increasing, and the full-frequency and miniaturization of speakers have become mainstream requirements. However, the space available for placing the speakers is small, and better sound quality cannot be achieved. If the bass speaker and treble speaker are assembled in one electronic device at the same time, not only will the space of the electronic device be compact, but the full-frequency effect of the speaker may also be affected.

In related technologies, the common full-frequency solution is to assemble the bass speaker and treble speaker into one electronic device, but due to the limited space of the electronic device, sizes of these two speakers are greatly restricted, which affects the full-frequency effects of the speakers, resulting in lower performance and making the speakers cannot achieve better sound quality. In addition, the treble unit usually plays a role in the treble performance, and the bass speaker usually plays a role in the midrange performance and the bass performance, so that the bass unit cannot give full play to the low-frequency performance of the bass speaker.

Based on the above ideas and problems, the present application proposes a sound-generating unit 100 that is highly integrated with the bass unit, the midrange unit and the treble unit. The sound-generating unit 100 not only ensures low-frequency and high-frequency performances, but also gives full play to the mid-frequency performance, thereby achieving a true full-frequency speaker. Moreover, the integrated design of the bass unit, the midrange unit and the treble unit of the sound-generating unit 100 can make full use of the limited space of the whole machine and improve the performance of the sound-generating unit 100.

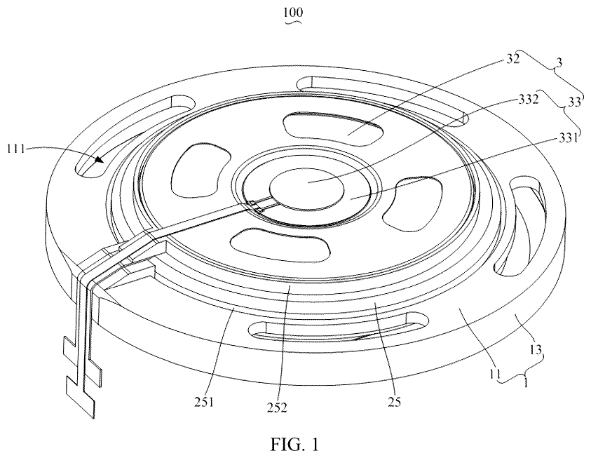

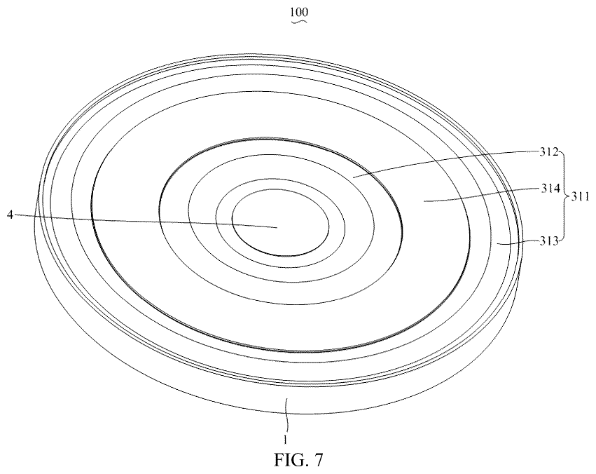

As shown in FIG. 1 to FIG. 9, in an embodiment of the present application, the sound-generating unit 100 includes a housing 1, a magnetic circuit system 2 and a vibration system 3. A conductive terminal 112 is formed at the housing 1 by injection molding, and the magnetic circuit system 2 is provided in the housing 1. The magnetic circuit system 2 has a bass magnetic gap 211 and a midrange magnetic gap 253. The vibration system 3 includes a bass vibration unit 31, a midrange vibration unit 32 and a treble vibration unit 33. The midrange vibration unit 32 and the treble vibration unit 33 are provided at the same side of the magnetic circuit system 2, and the midrange vibration unit 32 is provided around the treble vibration unit 33. The bass vibration unit 31 is provided at the other side of the magnetic circuit system 2. The vibration unit 31 includes a bass vibration diaphragm 311 and a bass voice coil 315. The bass voice coil 315 is provided in the bass magnetic gap 211. The midrange vibration unit 32 includes a midrange vibration diaphragm 321 and a midrange voice coil 325. The midrange voice coil 325 is provided in the midrange magnetic gap 253, and the treble vibration unit 33 is a piezoelectric unit.

In this embodiment, the sound-generating unit 100 can be a speaker unit, and the speaker can be a micro speaker. It should be noted that the housing 1 of the sound-generating unit 100 can be used for installation, fixation, support, and protection of the components, such as the magnetic circuit system 2 and the vibration system 3. That is, the housing 1 provides an installation basis for the components, such as the magnetic circuit system 2 and the vibration system 3.

It can be understood that the outer contour of the housing 1 can be a circular structure, an elliptical structure, a square structure or a polygonal structure, and the specific shape structure of the housing 1 can be designed according to actual needs, which is not limited here. Of course, the structures of the magnetic circuit system 2 and the vibration system 3 can be set according to the outer contour of the housing 1, which is not limited here.

It should be noted that the housing 1 has space for accommodating components such as the magnetic circuit system 2 and the vibration system 3. In an embodiment, the housing 1 is provided with a cavity. It can be understood that the housing 1 can be an integral structure or may include a plurality of split structures, which is not limited here. The housing 1 in this embodiment can be a circular structure, or a square frame, or just a frame structure. That is, the housing 1 has a cavity with two ends communicating with each other. The magnetic circuit system 2 and the vibration system 3 are accommodated in the cavity of the housing 1 and are provided relative to each other, so that the magnetic circuit system 2, the housing 1 and the vibration diaphragm assembly 31 of the vibration system 3 are enclosed to form a vibration cavity.

It can be understood that the sound-generating unit 100 can be applied to the electronic device, that is, the sound-generating unit 100 can be installed in the electronic device through the housing 1. It should be noted that the housing 1 of the sound-generating unit 100 can be a housing or a box structure independent of the electronic device. In this case, the housing 1 is used to integrate the components such as the magnetic circuit system 2 and the vibration system 3 of the sound-generating unit 100 into an integral structure, so as to facilitate disassembly and assembly. Of course, the housing 1 of the sound-generating unit 100 can also be a structure integrally formed with the housing of the electronic device or the box structure of the electronic device, which can effectively improve the structural strength and sealing performance.

In order to realize the full-frequency and miniaturization of the sound-generating unit 100, in an embodiment, the magnetic circuit system 2 is provided in the housing 1, and the midrange vibration unit 32 and the treble vibration unit 33 of the vibration system 3 are provided at the same side of the magnetic circuit system 2. Further, the midrange vibration unit 32 is provided around the treble vibration unit 33, and the bass vibration unit 31 is provided at the other side of the magnetic circuit system 2. In this way, the bass vibration unit 31, the midrange vibration unit 32 and the treble vibration unit 33 of the vibration system 3 are integrated at the opposite sides of the magnetic circuit system 2 synchronously, and are integrated into one integrated structure, so that not only the bass vibration unit 31, the midrange vibration unit 32 and the treble vibration unit 33 of the vibration system unit 33 are designed independently and do not affect each other, but also the high integration of the bass vibration unit 31, the midrange vibration unit 32 and the treble vibration unit 33 is realized. Thus, less space is occupied by the bass vibration unit 31, the midrange vibration unit 32 and the treble vibration unit 33, thereby improving space utilization.

In this embodiment, the side of the sound-generating unit 100 provided with the midrange vibration diaphragm 321 is the front side, and the side of the sound-generating unit 100 provided with the bass vibration diaphragm 311 is the back side. By setting the midrange vibration unit 32 and the treble vibration unit 33 at the same side of the sound-generating unit 100, the bass-treble effect of the sound-generating unit 100 is ensured.

In an embodiment, the bass vibration unit 31, the midrange vibration unit 32 and the treble vibration unit 33 of the vibration system 3 are coaxially provided. It can be understood that by setting the bass vibration unit 31, the midrange vibration unit 32 and the treble vibration unit 33 of the vibration system 3 to a coaxial arrangement structure, the magnetic circuit system 2 can be shared, and the Z-axis space of the sound-generating unit 100 can be utilized, which not only achieves the full-frequency design of the sound-generating unit 100, but also enables the sound-generating unit 100 to occupy a small space and have high applicability of the whole machine, so that it is very in line with the current development requirement for high sound quality of the speaker. Compared with the conventional speaker that mechanically assemble three devices of the bass speaker, the midrange speaker and the treble speaker into one structure, the space occupied by the sound-generating unit 100 of the present application is smaller and the space adaptability of the whole machine is higher. In addition, three units of the bass vibration unit 31, the midrange vibration unit 32 and the treble vibration unit 33 of the vibration system 3 are highly integrated into one structure, but the assembly process of each component is still a conventional process flow. The assembly process is simple, mature and mass-producible.

In this embodiment, the housing 1 is provided with a bass sound outlet 111. In an embodiment, the midrange vibration unit 32, the treble vibration unit 33 and the bass sound outlet 111 are provided at the same side of the sound-generating unit 100, and sound waves of the bass vibration diaphragm 311 radiate outward via the bass sound outlet 111. In this way, the bass unit, the midrange unit and the treble unit of the sound-generating unit 100 can sound from the same side, that is, the bass unit, the midrange unit and the treble unit of the sound-generating unit 100 can sound from the front side of the sound-generating unit 100.

It can be understood that the bass vibration unit 31, the midrange vibration unit 32 and the treble vibration unit 33 of the sound-generating unit 100 are not only coaxially designed, but also independently designed to meet the different needs of the bass unit, the midrange unit and the treble unit, so that each vibration unit is independent of each other and does not affect each other, ensuring that the bass unit, the midrange unit and the treble unit can sound coaxially in the same direction. Further, the three-band sound can coordinate better and the sound quality is better.

In this embodiment, the bass vibration unit 31 and the midrange vibration unit 32 of the sound-generating unit 100 can be designed in a moving-coil speaker, and the treble vibration unit 33 can be designed in a piezoelectric speaker or a moving-coil speaker, to meet different performance requirements of the whole machine.

For the sound-generating unit 100 of the present application, a magnetic circuit system 2 is provided in a housing 1. A bass magnetic gap 211 and a midrange magnetic gap 253 are provided in the magnetic circuit system 2. A midrange vibration unit 32 and a treble vibration unit 33 of a vibration system 3 are provided at the same side of the magnetic circuit system 2, making the midrange vibration unit 32 surround the treble vibration unit 33. Further, the bass vibration unit 31 is provided at the other side of the magnetic circuit system 2, so that the bass voice coil 315 of the bass vibration unit 31 is provided in the bass magnetic gap 211, and the midrange voice coil 325 of the midrange vibration unit 32 is provided in the midrange magnetic gap 253. The treble vibration unit 33 is the piezoelectric unit. In this way, the bass vibration unit 31, the midrange vibration unit 32 and the treble vibration unit 33 of the vibration system 3 are integrated into one structure, the magnetic circuit system 2 can be shared, and the Z-axis space of the sound-generating unit 100 can be utilized, thereby realizing a sound-generating unit 100 that is highly integrated with the bass unit, the midrange unit and the treble unit. In this way, the space occupied by the sound-generating unit 100 is smaller, and the space adaptability of the whole machine is higher. Further, the bass vibration unit 31, the midrange vibration unit 32 and the treble vibration unit 33 of the vibration system 3 play a role in the sound of their respective frequency bands, and the best sound quality experience of the whole machine can be achieved according to the whole machine effect. Thus, under the premise of ensuring the advantages of low-frequency and high-frequency performance, not only the mid-frequency performance can be fully utilized, but also the full-frequency and miniaturization can be realized, and the performance of the sound-generating unit 100 can be effectively improved.

In this embodiment, electrical signals can pass through the bass voice coil 315 of the bass vibration unit 31 and the midrange voice coil 325 of the midrange vibration unit 32. The bass voice coil 315 and the midrange voice coil 325 can be in the cylindrical shape. In an embodiment, one end of the bass voice coil 315 is connected to the bass vibration diaphragm 311, and the other end of the bass voice coil 315 is suspended in the bass magnetic gap 211 of the magnetic circuit system 2. One end of the midrange voice coil 325 is connected to the midrange vibration diaphragm 321, and the other end of the midrange voice coil 325 is suspended in the midrange magnetic gap 253 of the magnetic circuit system 2.

It should be noted that the bass voice coil 315 or the midrange voice coil 325 can be the flat voice coil, which is fixed to the side of the bass vibration diaphragm 311 or the midrange vibration diaphragm 321 facing the magnetic circuit system 2, and is opposite to and spaced from the bass magnetic gap 211 or the midrange magnetic gap 253 of the magnetic circuit system 2. That is, the other end of the bass voice coil 315 or the midrange voice coil 325 is provided outside the bass magnetic gap 211 or the midrange magnetic gap 253 along the vibration direction of the vibration system 3, and the other end of the bass voice coil 315 or the midrange voice coil 325 is opposite to the bass magnetic gap 211 or the midrange magnetic gap 253. Or, the bass voice coil 315 or the midrange voice coil 325 is the ring racetrack voice coil. In this case, one end of the bass voice coil 315 or the midrange voice coil 325 is connected to the bass vibration diaphragm 311 or the midrange vibration diaphragm 321, and the other end of the bass voice coil 315 or the midrange voice coil 325 is suspended in the bass magnetic gap 211 or the midrange magnetic gap 253, which is not limited here.

In an embodiment, the bass voice coil 315 and the midrange voice coil 325 include a frame and a voice coil wire provided at the frame. In an embodiment, the bass voice coil 315 and the midrange voice coil 325 are structures formed by winding the voice coil wire around the frame. In this embodiment, the voice coil wire can be made of the metal material that current can pass through. The frame of the bass voice coil 315 and the midrange voice coil 325 can be shaped in the circular cylinder, a square cylinder, a racetrack, or other cylinders, which will not be limited here.

In this embodiment, in order to facilitate transmitting electrical signals to the bass voice coil 315 and the midrange voice coil 325, a flexible circuit board can be provided, and the flexible circuit board is used to connect and conduct the external circuit with the bass voice coil 315 and the midrange voice coil 325 of the sound-generating unit 100. It can be understood that the flexible circuit board is provided with an inner pad and an outer pad, and the inner pad of the flexible circuit board is connected and conducted with the bass voice coil 315 or the midrange voice coil 325 of the sound-generating unit 100, and the outer pad of the flexible circuit board is used to connect with an external terminal or an external circuit.

It should be noted that the flexible circuit board can be provided in the cavity of the housing 1, or the flexible circuit board can be provided outside the cavity of the housing 1, as long as the electric signal can be transmitted to the bass voice coil 315 and the midrange voice coil 325 through the flexible circuit board, which is not limited here.

Of course, the conductive terminal 112 can further be provided at the housing 1, and the conductive terminal 112 is connected to the voice coil lead of the bass voice coil 315 or the voice coil lead of the midrange voice coil 325. Then the conductive terminal 112 is connected to the external terminal or the external circuit through the flexible circuit board. In an embodiment, the conductive terminal 112 is formed at the housing 1 through injection molding, so that the structure and processing steps of the housing 1 can be simplified.

In this embodiment, the treble vibration unit 33 can a piezoelectric unit. Of course, in other embodiments, the treble vibration unit 33 includes a treble vibration diaphragm 333 and a treble voice coil 334, and the magnetic circuit system 2 is further provided with a treble magnetic gap 261. One end of the treble voice coil 334 is connected to the treble vibration diaphragm 333, and the other end of the treble voice coil 334 is suspended in the treble magnetic gap 261 of the magnetic circuit system 2.

It can be understood that, electrical signals can pass through the treble voice coil 334 of the treble vibration unit 33. The treble voice coil 334 can be in a cylindrical shape. The treble voice coil 334 includes a frame and a voice coil wire provided at the frame. In an embodiment, the treble voice coil 334 is a structure formed by winding the voice coil wire around the frame. In this embodiment, the voice coil wire can be made of the metal material that current can pass through. The frame of the treble voice coil 334 can be a circular cylinder, a square cylinder, a racetrack shape, or other shapes of cylinders, which are not limited here.

It should be noted that, in order to facilitate transmitting electrical signals to the treble voice coil 334, a flexible circuit board can be provided, and the flexible circuit board is used to connect and conduct the external circuit to the treble voice coil 334 of the sound-generating unit 100. It can be understood that the flexible circuit board is provided with an inner pad and an outer pad. The inner pad of the flexible circuit board is connected and conducted with the treble voice coil 334 of the sound-generating unit 100, and the outer pad of the flexible circuit board is used to connect to an external terminal or an external circuit.

It should be noted that the flexible circuit board can be provided in the cavity of the housing 1, or the flexible circuit board can be provided outside the cavity of the housing 1, as long as the electrical signal can be transmitted to the treble voice coil 334 through the flexible circuit board, and no limitation is made here.

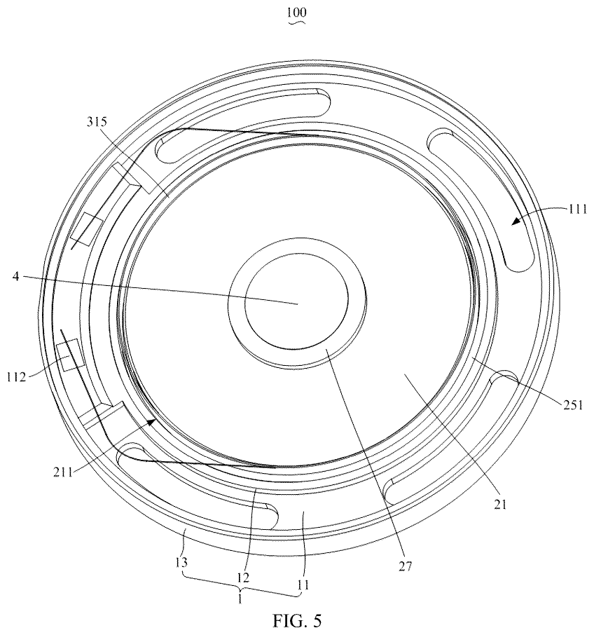

Of course, as shown in FIG. 5, a conductive terminal 112 may further be provided in the housing 1, and the conductive terminal 112 is connected to the voice coil lead of the treble voice coil 334. Then the conductive terminal 112 is connected to an external terminal or an external circuit through the flexible circuit board. In an embodiment, the conductive terminal 112 is formed at the housing 1 by injection molding, which can simplify the structure and processing steps of the housing 1.

In an embodiment, the magnetic circuit system 2 includes a first magnetic conductive piece 21, a center magnet 22, an edge magnet 23, a center magnetic conductive piece 24 and an edge magnetic conductive piece 25. The center magnet 22 and the edge magnet 23 are provided at the first magnetic conductive piece 21. The center magnetic conductive piece 24 is provided at the side of the center magnet 22 away from the first magnetic conductive piece 21. The edge magnetic conductive piece 25 is provided at the side of the edge magnet 23 away from the first magnetic conductive piece 21. The edge magnetic conductive piece 25 is provided with a sidewall 251. The bass magnetic gap 211 is formed between the sidewall 251 and the first magnetic conductive piece 21. The midrange magnetic gap 253 is formed between the center magnetic conductive piece 24 and the edge magnetic conductive piece 25.

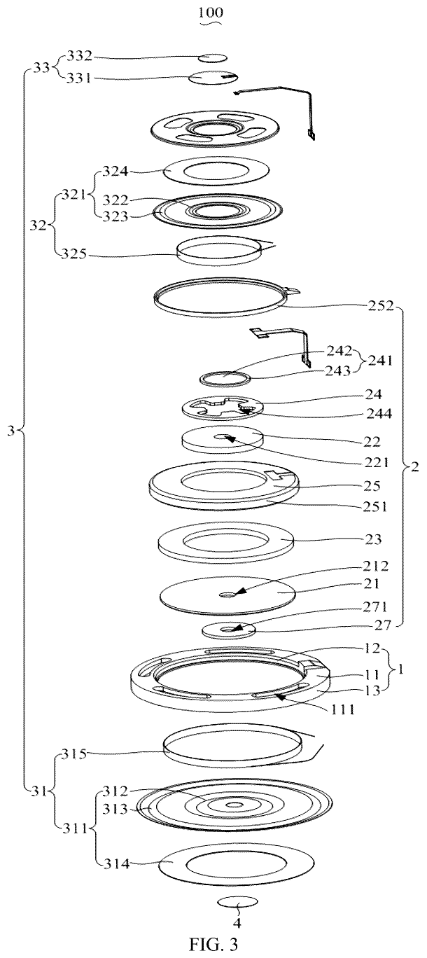

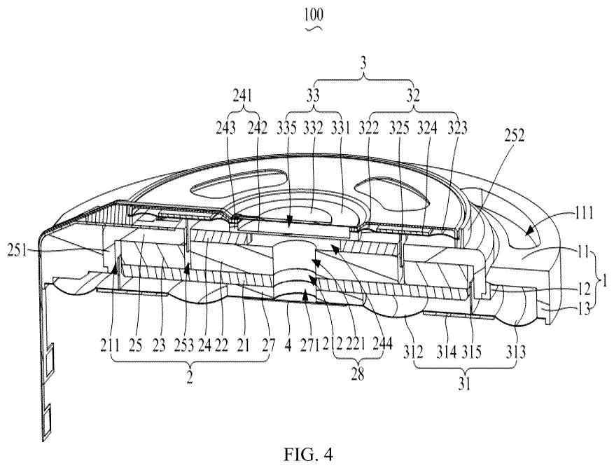

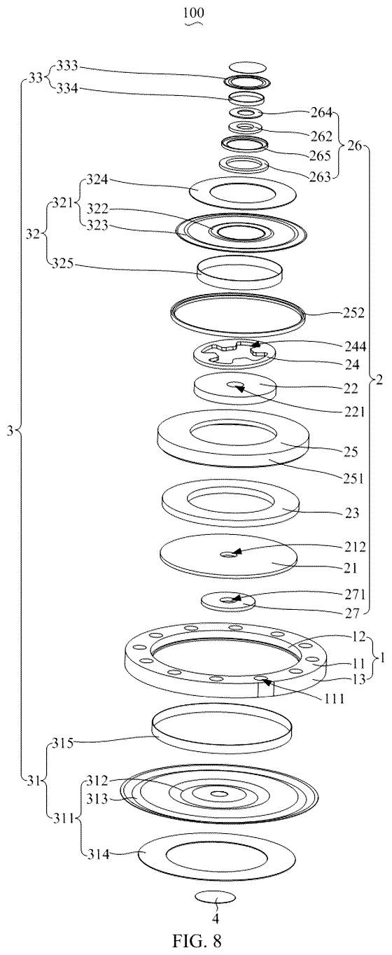

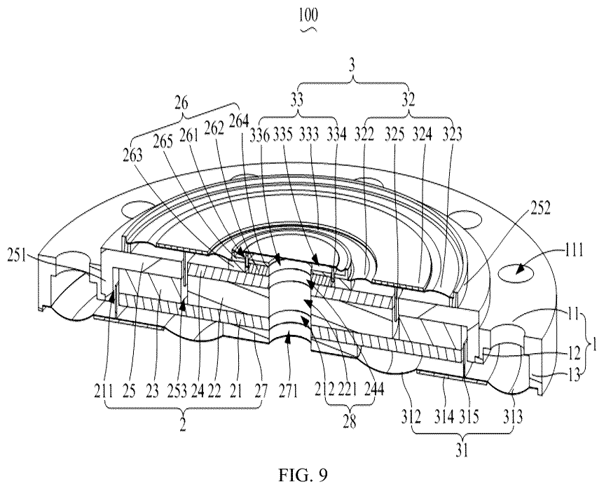

In an embodiment, as shown in FIG. 3, FIG. 4, FIG. 8 and FIG. 9, the first magnetic conductive piece 21 of the magnetic circuit system 2 may be a magnetic conductive plate structure. The center magnet 22 and the center magnetic conductive piece 24 are stacked to form a center magnetic circuit portion. The edge magnet 23 and the edge magnetic conductive piece 25 are stacked to form an edge magnetic circuit portion. It can be understood that the edge magnet 23 and the edge magnetic conductive piece 25 of the edge magnetic circuit portion are provided outside the center magnet 22 and the center magnetic conductive piece 24 of the center magnetic circuit portion, and are spaced to form a midrange magnetic gap 253. In an embodiment, the center magnet 22 and the edge magnet 23 are arranged at intervals on the first magnetic conductive piece 21. The center magnetic conductive piece 24 is provided at the side of the center magnet 22 away from the first magnetic conductive piece 21. The edge magnetic conductive piece 25 is provided at the side of the edge magnet 23 away from the first magnetic conductive piece 21. In an embodiment, the center magnetic conductive piece 24 and the edge magnetic conductive piece 25 can be magnetic conductive plate structures.

It should be noted that the center magnetic circuit portion includes one or more center magnet 22 and one or more center magnetic conductive piece 24, and the center magnet 22 and the center magnetic conductive piece 24 are stacked. When there are multiple center magnets 22 and multiple center magnetic conductive pieces 24, the multiple center magnets 22 and the multiple center magnetic conductive pieces 24 are alternately stacked, and one center magnet 22 is connected to the first magnetic conductive piece 21. When only one center magnet 22 and only one center magnetic conductive piece 24 are provided, the center magnet 22 is clamped between the center magnetic conductive piece 24 and the first magnetic conductive piece 21.

It can be understood that the center magnet 22 can be a circular plate structure, or a square plate structure, or a disk structure. Or the center magnet 22 is shaped in a ring structure (that is, a through-hole structure is formed in the center of the center magnet 22). Or the center magnet 22 may be shaped in a plurality of strip structures, and the plurality of strip structures are enclosed to form a ring structure, then a plurality of strip structures are enclosed to form a through-hole structure, which is not limited here.

In an embodiment, the shape contour of the center magnetic conductive piece 24 is the same as or similar to the shape contour of the center magnet 22. For example, the center magnetic conductive piece 24 can be a circular plate structure or a square plate structure, or can be a disk structure. Or the center magnetic conductive piece 24 is shaped in a ring structure (that is, a through-hole structure is formed in the center of the center magnetic conductive piece 24), or the center magnetic conductive piece 24 is shaped in a plurality of strip structures, and the plurality of strip structures are enclosed to form a ring structure, so that a plurality of strip structures are enclosed to form a through-hole structure, which is not limited here.

In this embodiment, the edge magnetic circuit portion includes one or more edge magnet 23 and one or more edge magnetic conductive piece 25. The edge magnets 23 and the edge magnetic conductive pieces 25 are stacked. When there are multiple edge magnets 23 and multiple edge magnetic conductive pieces 25, the multiple edge magnets 23 and the multiple edge magnetic conductive pieces 25 are alternately stacked, and one edge magnet edge magnet 23 is connected to the first magnetic conductive piece 21. When only one edge magnet 23 and only one edge magnetic conductive piece 25 are provided, the edge magnet 23 is clamped between the edge magnetic conductive piece 25 and the first magnetic conductive piece 21.

In an embodiment, the edge magnet 23 and the edge magnetic conductive piece 25 of the edge magnetic circuit portion can be arranged in the annular shape. Then the annular edge magnetic circuit portion is provided outside the center magnetic circuit portion, and is spaced apart from the center magnetic circuit portion to form a midrange magnetic gap 253. In an embodiment, the edge magnet 23 and/or the edge magnetic conductive piece 25 are enclosed to form a closed integral annular structure.

Of course, in other embodiments, there are multiple edge magnets 23 and multiple edge magnetic conductive pieces 25 of the edge magnetic circuit portion. Multiple edge magnetic circuit portions are provided around the outside of the center magnetic circuit portion, and are spaced apart from the center magnetic circuit portion to form a midrange magnetic gap 253. In an embodiment, multiple edge magnets 23 and multiple edge magnetic conductive pieces 25 are provided, and one edge magnet 23 corresponds to one edge magnetic conductive piece 25. The adjacent edge magnets 23 are connected to each other in an end-to-end manner to form a closed ring structure. Or, the edge magnet 23 forms a closed integral ring structure, and multiple edge magnetic conductive pieces 25 are provided. The adjacent edge magnetic conductive pieces 25 are connected to each other in an end-to-end manner, to form a closed ring structure, and the closed ring structure is corresponding to the ring edge magnet 23. Or, the edge magnetic conductive piece 25 forms a closed integral ring structure, and there are multiple edge magnets 23. Adjacent edge magnets 23 are connected to each other in an end-to-end manner, to form a closed ring structure, and the closed ring structure is corresponding to the ring edge magnetic conductive piece 25, which is not limited here.

In an embodiment, as shown in FIG. 3, FIG. 4, FIG. 8 and FIG. 9, the edge magnetic conductive piece 25 has a sidewall 251, and a bass magnetic gap 211 is formed between the sidewall 251 of the edge magnetic conductive piece 25 and the first magnetic conductive piece 21. It can be understood that the cross-section of the edge magnetic conductive piece 25 can be an L-shaped structure. The edge magnetic conductive piece 25 includes a straight portion and a sidewall 251, and an angle is formed between the straight portion and the sidewall 251. The straight portion of the edge magnetic conductive piece 25 is stacked with the edge magnet 23, and the sidewall 251 of the edge magnetic conductive piece 25 surrounds the outside of the first magnetic conductive piece 21 and is spaced from the first magnetic conductive piece 21 to form a bass magnetic gap 211.

In an embodiment, the magnetic circuit system 2 further includes a treble magnetic circuit unit 26 provided in a center magnetic conductive piece 24. The treble magnetic circuit unit 26 is provided with a treble magnetic gap 261, and the treble vibration unit 33 includes a treble vibration diaphragm 333 and a treble voice coil 334. The treble voice coil 334 is provided in the treble magnetic gap 261.

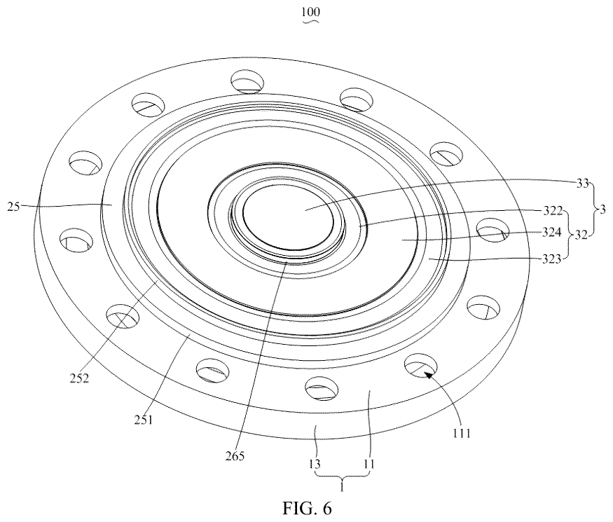

In an embodiment, as shown in FIG. 6 to FIG. 9, the treble vibration unit 33 may be designed as a moving-coil speaker structure. The treble vibration unit 33 includes a treble vibration diaphragm 333 and a treble voice coil 334. The magnetic circuit system 2 further includes a treble magnetic circuit unit 26, which is provided at the side of the center magnetic conductive piece 24 away from the first magnetic conductive piece 21. The treble magnetic circuit unit 26 is provided with a treble magnetic gap 261. One end of the treble voice coil 334 is connected to the treble vibration diaphragm 333, and the other end of the treble voice coil 334 is suspended in the treble magnetic gap 261.

It should be noted that the treble voice coil 334 can be a flat voice coil, which is fixed to the side of the treble vibration diaphragm 333 facing the treble magnetic circuit unit 26, and is opposite to and spaced from the treble magnetic gap 261 of the treble magnetic circuit unit 26. That is, the other end of the treble voice coil 334 is provided outside the treble magnetic gap 261 along the vibration direction of the vibration system 3. The other end of the treble voice coil 334 is opposite to the treble magnetic gap 261. Or the treble voice coil 334 is shaped in a ring racetrack. In this case, one end of the treble voice coil 334 is connected to the treble vibration diaphragm 333, and the other end of the treble voice coil 334 is suspended in the treble magnetic gap 261, which is not limited here.

In an embodiment, the treble magnetic circuit unit 26 includes an inner magnet 262, an outer magnet 263, an inner edge magnetic conductive piece 264 provided at the inner magnet 262, and an outer edge magnetic conductive piece 265 provided at the outer magnet 263. A treble magnetic gap 261 is formed between the inner edge magnetic conductive piece 264 and the outer edge magnetic conductive piece 265, and the edge of the treble vibration diaphragm 333 is connected to the outer edge magnetic conductive piece 265.

In this embodiment, as shown in FIG. 6, FIG. 8 and FIG. 9, the inner magnet 262 and the outer magnet 263 are spaced apart from each other and are set on the side of the center magnetic conductive piece 24 away from the center magnet 22. The outer magnet 263 is provided at the outside of the inner magnet 262 and spaced apart to form a treble magnetic gap 261. In an embodiment, the inner edge magnetic conductive piece 264 and the inner magnet 262 are stacked to form a center magnetic portion, and the outer edge magnetic conductive piece 265 and the outer magnet 263 are stacked to form an edge magnetic portion.

It can be understood that the outer magnet 263 of the edge magnetic portion and the outer edge magnetic conductive piece 265 of the edge magnetic portion are provided outside the inner magnet 262 of the center magnetic portion and the inner edge magnetic conductive piece 264, and are spaced apart each other to form a treble magnetic gap 261. In an embodiment, the inner edge magnetic conductive piece 264 and the outer edge magnetic conductive piece 265 can be the magnetic conductive plate structure.

It should be noted that the center magnetic portion includes one or more inner magnet 262 and one or more inner edge magnetic conductive piece 264. The inner magnets 262 and the inner edge magnetic conductive piece 264 are stacked. When there are multiple inner magnets 262 and multiple inner edge magnetic conductive pieces 264, the multiple inner magnets 262 and the multiple inner edge magnetic conductive piece 264 are alternately stacked, and one inner magnet 262 is connected to the center magnetic conductive piece 24. When only one inner magnet 262 and only one inner edge magnetic conductive piece 264 are provided, the inner magnet 262 is clamped between the inner edge magnetic conductive piece 264 and the center magnetic conductive piece 24.

It can be understood that the inner magnet 262 can be a circular plate structure, or in a square plate structure, or can be a disk structure. Or the inner magnet 262 is arranged in an annular structure (that is, a through-hole structure is formed in the center of the inner magnet 262), or can be shaped in a plurality of strip structures. The plurality of strip structures are enclosed to form an annular structure, so that a plurality of strip structures are enclosed to form a through-hole structure, which is not limited here.

In an embodiment, the shape contour of the inner edge magnetic conductive piece 264 is the same as or similar to the shape contour of the inner magnet 262. For example, the inner edge magnetic conductive piece 264 can be a circular plate structure, or a square plate structure, or a disk structure. Or the inner edge magnetic conductive piece 264 is arranged in an annular structure (that is, a through-hole structure is formed in the center of the inner edge magnetic conductive piece 264), or can be shaped in a plurality of strip structures. The plurality of strip structures are enclosed to form an annular structure, so that a plurality of strip structures are enclosed to form a through-hole structure, which is not limited here.

In this embodiment, the edge magnetic portion includes one or more outer magnet 263 and one or more outer edge magnetic conductive piece 265. The outer magnet 263 and the outer edge magnetic conductive piece 265 are stacked. When there are multiple outer magnets 263 and multiple outer edge magnetic conductive pieces 265, the multiple outer magnets 263 and the multiple outer edge magnetic conductive piece 265 are alternately stacked, and one outer magnet 263 is connected to the center magnetic conductive piece 24. When only one outer magnet 263 and only one outer edge magnetic conductive piece 265 are provided, the outer magnet 263 is clamped between the outer edge magnetic conductive piece 265 and the center magnetic conductive piece 24.

In an embodiment, the outer magnet 263 and the outer edge magnetic conductive piece 265 of the edge magnetic portion can be in the annular shape. Then the annular edge magnetic portion is provided at the outside of the center magnetic portion, and is spaced apart from the center magnetic portion to form a treble magnetic gap 261. In an embodiment, the outer magnet 263 and/or the outer edge magnetic conductive piece 265 are enclosed to form a closed integrated ring structure.

Of course, in other embodiments, there are multiple outer magnets 263 and multiple outer edge magnetic conductive pieces 265 of the edge magnetic portion. The multiple edge magnetic portions are provided around the outside of the center magnetic portion and are spaced apart from the center magnetic portion to enclose and form a high-frequency magnetic gap 261. In an embodiment, there are multiple outer magnets 263 and multiple outer edge magnetic conductive pieces 265, and one outer magnet 263 corresponds to one outer edge magnetic conductive piece 265. Adjacent outer magnets 263 are connected to each other in an end-to-end manner to form a closed ring structure. Or, the outer magnet 263 forms a closed integral ring structure, and multiple outer edge magnetic conductive pieces 265 are provided. The adjacent outer edge magnetic conductive pieces 265 are connected to each other in an end-to-end manner to form a closed ring structure, and is corresponding to the annular outer magnet 263. Or, the outer edge magnetic conductive pieces 265 form a closed integral ring structure, and multiple outer magnets 263 are provided. Adjacent outer magnets 263 are connected to each other in an end-to-end manner to form a closed ring structure, and is corresponding to the annular outer edge magnetic conductive piece 265, which is not limited here.

In this embodiment, as shown in FIG. 6, FIG. 8 and FIG. 9, the edge of the treble vibration diaphragm 333 is connected to the outer edge magnetic conductive piece 265. In order to avoid interference between the treble vibration diaphragm 333 and the treble magnetic circuit unit 26 during the vibration process, in an embodiment, the outer edge magnetic conductive piece 265 is provided with a fixation platform, and the edge of the treble vibration diaphragm 333 is connected to the fixation platform of the outer edge magnetic conductive piece 265.

It can be understood that the fixation platform can extend from the outer edge magnetic conductive piece 265 along a direction away from the outer magnet 263, so that the treble vibration diaphragm 333 can be supported to a certain height. In this embodiment, the fixation platform and the outer edge magnetic conductive piece 265 can be an integrally formed structure or a split structure, and can be connected into a whole by welding or bonding, which is not limited here.

In an embodiment, the magnetization direction of one of the inner magnet 262 and the outer magnet 263 is opposite to the magnetization direction of the center magnet 22, and the magnetization direction of the other one of the inner magnet 262 and the outer magnet 263 is the same as the magnetization direction of the center magnet 22.

In this embodiment, by making the magnetization direction of the inner magnet 262 opposite to the magnetization direction of the outer magnet 263, the magnetic flux of the treble magnetic gap 261 is increased, so that the driving force of the treble voice coil 334 can be increased to improve the sound effect of the treble speaker.

It can be understood that in order to further increase the magnetic flux of the treble magnetic gap 261 and the midrange magnetic gap 253, the magnetization direction of the center magnet 22 is opposite to the magnetization direction of one of the inner magnet 262 and the outer magnet 263, and the magnetization direction of the other one of the inner magnet 262 and the outer magnet 263 is the same as the magnetization direction of the center magnet 22. For example, when the center magnet 22 and the inner magnet 262 are magnetized upward, the outer magnet 263 is magnetized downward. Or, when the center magnet 22 and the outer magnet 263 are magnetized upward, the inner magnet 262 is magnetized downward, which is not limited here.

In an embodiment, the bass vibration diaphragm 311 is provided with a bass inner folding ring 312, a bass outer folding ring 313 and a bass vibration plate 314. The bass inner folding ring 312 is connected to the magnetic circuit system 2, and the bass outer folding ring 313 is connected to the housing 1.

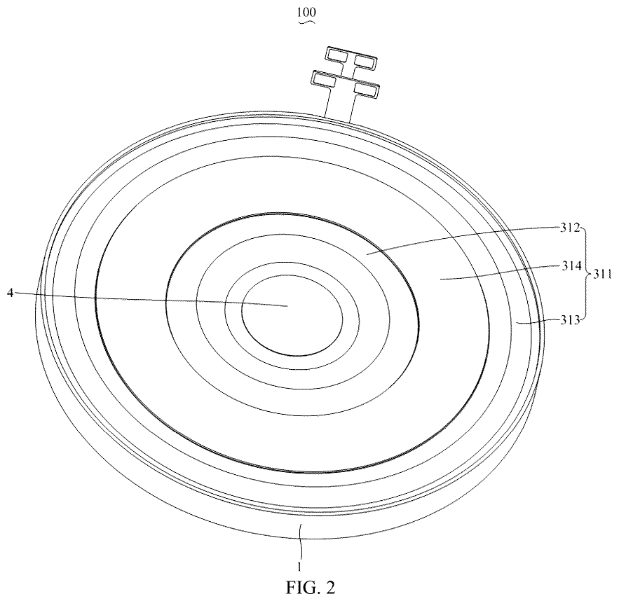

In this embodiment, as shown in FIG. 2 to FIG. 4 and FIG. 7 to FIG. 9, by setting the bass vibration diaphragm 311 as a double folding ring structure, the bass vibration diaphragm 311 is connected to the magnetic circuit system 2 through the bass inner folding ring 312, and the bass outer folding ring 313 is connected to the housing 1, thereby improving the connection stability of the bass vibration diaphragm 311.

It can be understood that the bass inner folding ring 312 is connected to the bass outer folding ring 313 of the bass vibration diaphragm 311 by a flat plate portion. The bass vibration plate 314 is provided between the bass inner folding ring 312 and the bass outer folding ring 313, and is connected to the flat plate portion to enhance the structural strength of the bass vibration diaphragm 311. In an embodiment, the bass vibration diaphragm 311 is an integrally formed structure. That is, the bass inner folding ring 312, the flat plate portion and the bass outer folding ring 313 form the integrally formed structure.

In this embodiment, the bass voice coil 315 is connected to the flat plate portion between the bass inner folding ring 312 and the bass outer folding ring 313. That is, the bass inner folding ring 312 and the bass outer folding ring 313 are provided at the inner and outer sides of the bass voice coil 315. It can be understood that the bass inner folding ring 312 and the bass outer folding ring 313 of the bass vibration diaphragm 311 can be the convex structure protruding upward or the concave structure depressing downward, which is not limited here.

In order to facilitate the connection between the bass vibration diaphragm 311 and the housing 1, the housing 1 is provided with a connection platform, and the outside of the bass outer folding ring 313 of the bass vibration diaphragm 311 is connected and fixed to the connection platform. It can be understood that an outer fixation portion is formed on the outside of the bass outer folding ring 313, and the bass vibration diaphragm 311 is connected and fixed to the connection platform of the housing 1 through the outer fixation portion, which is not limited here.

In an embodiment, a support block 27 is provided at the side of the magnetic circuit system 2 close to the bass vibration unit 31, and the bass inner folding ring 312 is fixed to the support block 27.

In this embodiment, as shown in FIG. 3 to FIG. 5, FIG. 8 and FIG. 9, by setting a support block 27 at the side of the magnetic circuit system 2 facing the bass vibration unit 31, the support block 27 can be used to further fix the bass vibration diaphragm 311 of the bass vibration unit 31, thereby further improving the connection stability of the bass vibration diaphragm 311. In an embodiment, the support block 27 can be a circular plate structure, or a square plate structure, or a disc structure.

It can be understood that the inner side of the bass inner folding ring 312 of the bass vibration diaphragm 311 is connected and fixed to the support block 27. In order to ensure the connection stability between the bass inner folding ring 312 and the support block 27, the inner side of the bass inner folding ring 312 extends to form a flat plate structure, and the bass vibration diaphragm 311 is connected and fixed to the support block 27 through the flat plate structure at the inner side of the bass inner folding ring 312.

In order to further improve the magnetic performance of the magnetic circuit system 2, in an embodiment, the support block 27 can be made of magnetic material. In an embodiment, the support block 27 can be a plate structure or a disk structure made of a magnet, or a magnetic plate, or a magnetic material.

In this embodiment, the magnetization direction of the support block 27 is opposite to the magnetization direction of the center magnet 22. It can be understood that, such a setting manner can effectively increase the magnetic conductivity of the first magnetic conductive piece 21, thus the magnetic flux of the bass magnetic gap 211 and the midrange magnetic gap 253 can be increased, thereby increasing the driving force for the bass voice coil 315 and the midrange voice coil 325.

In another embodiment, the support block 27 can be made of non-magnetic material. It can be understood that the support block 27 plays a role in supporting and fixing the bass vibration diaphragm 311, which is not limited here.

In an embodiment, the midrange vibration diaphragm 321 includes a midrange inner folding ring 322, a midrange outer folding ring 323 and a midrange vibration plate 324. The midrange inner folding ring 322 is connected to the center magnetic conductive piece 24, and the midrange outer folding ring 323 is connected to the edge magnetic conductive piece 25.

In this embodiment, as shown in FIG. 3, FIG. 4, FIG. 6, FIG. 8 and FIG. 9, the midrange vibration diaphragm 321 is a double folding ring structure, thus the midrange vibration diaphragm 321 is connected to the center magnetic conductive piece 24 through the midrange inner folding ring 322, and the midrange outer folding ring 323 is connected to the edge magnetic conductive piece 25, thereby improving the connection stability of the midrange vibration diaphragm 321.

It can be understood that the midrange inner folding ring 322 of the midrange vibration diaphragm 321 is connected to the midrange outer folding ring 323 of the midrange vibration diaphragm 321 by a flat plate portion. The midrange vibration plate 324 is provided between the midrange inner folding ring 322 and the midrange outer folding ring 323, and is connected to the flat plate portion to enhance the structural strength of the midrange vibration diaphragm 321. In an embodiment, the midrange vibration diaphragm 321 is an integrally formed structure, that is, the midrange inner folding ring 322, the flat plate portion and the midrange outer folding ring 323 form an integrally formed structure.

In this embodiment, the midrange voice coil 325 is connected to the flat plate portion between the midrange inner folding ring 322 and the midrange outer folding ring 323. That is, the midrange inner folding ring 322 and the midrange outer folding ring 323 are provided at the inner and outer sides of the midrange voice coil 325. It can be understood that the midrange inner folding ring 322 of the midrange vibration diaphragm 321 and the midrange outer folding ring 323 of the midrange vibration diaphragm 321 can be the convex structure protruding upward or the concave structure depressing downward, which is not limited here.

In order to facilitate the connection between the midrange vibration diaphragm 321 and the edge magnetic conductive piece 25, the edge magnetic conductive piece 25 is provided with a connection platform, and the outside of the midrange outer folding ring 323 of the midrange vibration diaphragm 321 is connected and fixed to the connection platform. It can be understood that, an outer fixation portion is formed at the outside of the midrange outer folding ring 323, and the midrange vibration diaphragm 321 is connected and fixed to the connection platform of the edge magnetic conductive piece 25 through the outer fixation portion, which is not limited here.

In an embodiment, the edge magnetic conductive piece 25 is provided with an outer bracket 252, and the midrange outer folding ring 323 is fixed to the outer bracket 252.

In this embodiment, as shown in FIG. 1, FIG. 3, FIG. 4, FIG. 6, FIG. 8 and FIG. 9, an outer bracket 252 is provided at the edge magnetic conductive piece 25, so that the outer bracket 252 is used to fix the midrange outer folding ring 323 of the midrange vibration diaphragm 321, and the midrange vibration diaphragm 321 is supported to a certain height to avoid interference between the midrange vibration diaphragm 321 and the edge magnetic conductive piece 25 during the vibration process. In an embodiment, the outer bracket 252 and the edge magnetic conductive piece 25 can be the integrally formed structure. Of course, in other embodiments, both the outer bracket 252 and the edge magnetic conductive piece 25 can be the split structures, and the split structures are connected into a whole by welding or bonding, which is not limited here.

It can be understood that the inner side of the midrange inner folding ring 322 of the midrange vibration diaphragm 321 is connected and fixed to the center magnetic conductive piece 24. In order to ensure the connection stability between the midrange inner folding ring 322 and the center magnetic conductive piece 24, the inner side of the midrange inner folding ring 322 is extended to form a flat plate structure, and the midrange vibration diaphragm 321 is connected and fixed to the center magnetic conductive piece 24 through the flat plate structure at the inner side of the midrange inner folding ring 322.

In an embodiment, the center magnetic conductive piece 24 is provided with an inner bracket 241, and the midrange inner folding ring 322 is fixed to the inner bracket 241.

In this embodiment, as shown in FIG. 1, FIG. 3, FIG. 4, FIG. 6, FIG. 8 and FIG. 9, an inner bracket 241 is provided in the center magnetic conductive piece 24, so that the inner bracket 241 is used to fix the midrange inner folding ring 322 of the midrange vibration diaphragm 321, and the midrange vibration diaphragm 321 is supported to a certain height to avoid interference between the midrange vibration diaphragm 321 and the center magnetic conductive piece 24 during the vibration process. In an embodiment, the inner bracket 241 and the center magnetic conductive piece 24 can be the integrally formed structure. Of course, in other embodiments, the inner bracket 241 and the center magnetic conductive piece 24 can be the split structures, and the split structures are connected into a whole by welding or bonding, which is not limited here.

In an embodiment, the midrange inner folding ring 322 is connected to the treble magnetic circuit unit 26. In this embodiment, as shown in FIG. 8 and FIG. 9, the midrange inner folding ring 322 of the midrange vibration diaphragm 321 is connected to the outer magnet 263 or the outer edge magnetic conductive piece 265, which is not limited here.

In an embodiment, a cover plate is further provided at the side of the midrange vibration diaphragm 321 away from the magnetic circuit system 2, and the cover plate is configured to cover the midrange vibration diaphragm 321 and forms a midrange front cavity with the midrange vibration diaphragm 321. The cover plate is provided with a midrange sound outlet hole communicating with the midrange front cavity. It can be understood that, by setting the cover plate and the midrange sound outlet hole, sound waves of the midrange vibration diaphragm 321 are radiated more concentratedly, thereby enhancing the midrange effect. Furthermore, the midrange sound outlet and the bass sound outlet 111 are provided at the same side of the housing, which is convenient for the midrange vibration unit and the bass vibration unit sound on the same side, thereby enhancing the midrange-bass sound quality. In an embodiment, the cover plate is in the annular shape, the inner edge of the cover plate is connected to the midrange inner folding ring 322, and the outer edge of the cover plate is connected to the midrange outer folding ring 323. The cover plate is made of metal, and the like.

In an embodiment, the treble vibration unit 33 can be a piezoelectric unit. In this embodiment, as shown in FIG. 1, FIG. 3 and FIG. 4, the treble vibration unit 33 includes a treble vibration plate 331 and a piezoelectric ceramic 332 provided at the treble vibration plate 331, and the edge of the treble vibration plate 331 is fixed to the inner bracket 241.

It can be understood that the piezoelectric ceramic 332 of the treble vibration unit 33 can be connected to the external circuit through a flexible circuit board or other electrical connectors, so that the piezoelectric ceramic 332 can drive the treble vibration plate 331 to vibrate by passing an electrical signal into the piezoelectric ceramic 332. In an embodiment, the piezoelectric ceramic 332 is provided at the center area of the treble vibration plate 331.

In this embodiment, the treble vibration unit 33 is a piezoelectric unit, and the treble magnetic circuit unit 26 may not be set, only the inner bracket 241 is provided at the center magnetic conductive piece 24, as long as the edge of the treble vibration plate 331 is fixed to the inner bracket 241.

In an embodiment, the inner bracket 241 is provided with a substrate 242 and a surrounding plate 243 provided around the periphery of the substrate 242. The treble vibration plate 331 is connected to the surrounding plate 243, and a treble back cavity 335 is formed between the treble vibration unit 33 and the inner bracket 241.

In this embodiment, the inner bracket 241 is provided with a substrate 242 and a surrounding plate 243, and an angle is formed between the substrate 242 and the surrounding plate 243, so that the surrounding plate 243 is provided around the periphery of the substrate 242. The surrounding plate 243 and the substrate 242 are enclosed to form a groove structure, so that the periphery of the treble vibration unit 33 is connected to the surrounding plate 243 to cover the groove structure. That is, a treble back cavity 335 is formed between the treble vibration unit 33 and the inner bracket 241. It can be understood that, in this case, the treble back cavity 335 is a closed back cavity.

Of course, the treble vibration unit 33 can be designed as a moving-coil speaker structure. That is, when the treble vibration diaphragm 333 and the treble voice coil 334 of the treble vibration unit 33 cooperate with the treble magnetic circuit unit 26, the periphery of the treble vibration diaphragm 333 is connected to the outer edge magnetic conductive piece 265, so that the treble vibration diaphragm 333 and the treble magnetic circuit unit 26 form a treble back cavity 335, which is not limited here. It can be understood that in order to balance the air pressure in the treble back cavity 335 when the treble vibration diaphragm 333 vibrates, the leakage hole that communicates the treble back cavity 335 can be formed at the treble vibration unit 33 and the treble magnetic circuit unit 26.

In an embodiment, the magnetic circuit system 2 is provided with a through hole 28, and the through hole 28 communicates with the external space of the sound-generating unit 100 and the midrange magnetic gap 253. The through hole 28 includes a first through hole 212 penetrating the first magnetic conductive piece 21, a second through hole 221 penetrating the center magnet 22, and a third through hole 244 penetrating the center magnetic conductive piece 24. The first through hole 212, the second through hole 221, and the third through hole 244 are communicated with each other.

In this embodiment, as shown in FIG. 2 to FIG. 5 and FIG. 7 to FIG. 9, the through hole 28 is provided at the magnetic circuit system 2, so that the through hole 28 communicates the external space of the sound-generating unit 100 and the midrange magnetic gap 253, to make a midrange back cavity formed by an enclosure of the midrange vibration unit 32 and the magnetic circuit system 2 to be an open structure.

It should be noted that the resonant frequency F0 of the sound-generating unit 100 is related to the compliance of the vibration diaphragm of the vibration system 3 and the volume of the back cavity of the sound-generating unit 100. In order to reduce the resonance frequency F0 of the sound-generating unit 100, the compliance of the vibration diaphragm or the volume of the back cavity is usually increased. That is to say, when the compliance of the vibration diaphragm cannot meet the requirements, the resonance frequency F0 of the sound-generating unit 100 can be reduced by adjusting the volume of the back cavity (that is, setting the back cavity to be an open structure). Or, in order to increase the resonance frequency F0 of the sound-generating unit 100, the back cavity can be set to a closed structure to increase the resonance frequency F0 of the sound-generating unit 100.

It can be understood that by setting a through hole 28 in the magnetic circuit system 2, the midrange magnetic gap 253 can communicate with the external space of the sound-generating unit 100 through the through hole 28, so that the midrange back cavity is set to be an open structure, thereby adjusting the midrange performance of the sound-generating unit 100.

In the embodiment, the through hole 28 includes a first through hole 212, a second through hole 221 and a third through hole 244 sequentially communicating with each other. That is, the first through hole 212, the second through hole 221 and the third through hole 244 communicate and cooperate with each other to form the through hole 28. The first through hole 212 is a through hole structure that penetrates the first magnetic conductive piece 21, the second through hole 221 is a through hole structure that penetrates the center magnet 22, and the third through hole 244 is a through hole structure that penetrates the center magnetic conductive piece 24. In an embodiment, the first through hole 212, the second through hole 221 and the third through hole 244 are coaxially provided. In an embodiment, the first through hole 212, the second through hole 221 and the third through hole 244 have similar shapes and contours, and may be polygonal holes or special-shaped holes, such as circular holes, elliptical holes, triangular holes, and square holes, and the like, which are not limited here.

In an embodiment, the outer contour of the third through hole 244 is formed outside the inner bracket 241. It can be understood that by providing the outer contour of the third through hole 244 outside the inner bracket 241, the through hole 28 can communicate the external space of the sound-generating unit 100 with the midrange magnetic gap 253, so that the midrange back cavity is set to be an open structure, thereby adjusting the midrange performance of the sound-generating unit 100.

In an embodiment, the treble back cavity 335 has a fourth through hole 336 that communicates the through hole 28. It can be understood that, as shown in FIG. 9, by setting the fourth through hole 336, the treble back cavity 335 communicates with the external space of the sound-generating unit 100 through the through hole 28, so that the treble back cavity 335 is set to be an open structure, thereby adjusting the treble performance of the sound-generating unit 100. Of course, in other embodiments, the treble back cavity 335 can further be set to be a closed structure, as shown in FIG. 4, which is not limited here.

In an embodiment, a support block 27 is provided at one side of the magnetic circuit system 2 close to the bass vibration unit 31, and the bass inner folding ring 312 is fixed to the support block 27. The support block 27 is provided with a fifth through hole 271 that communicates with the through hole 28.

In this embodiment, as shown in FIG. 3, FIG. 4, FIG. 8 and FIG. 9, by setting a fifth through hole 271 at the support block 27, the through hole 28 can conveniently communicate with the external space of the sound-generating unit 100 through the fifth through hole 271, so that the treble back cavity 335 and the midrange back cavity can be the closed structure or the open structure, thereby ensuring the resonance frequency F0 of the sound-generating unit 100 and improving the performance of the sound-generating unit 100.

In an embodiment, the through hole 28 is provided with a breathable spacer 4. In this embodiment, as shown in FIG. 2 to FIG. 5 and FIG. 7 to FIG. 8, by setting a breathable spacer 4, the through hole 28 is covered by the breathable spacer 4 to prevent debris or dust from entering the sound-generating unit 100 and affecting the sound effect of the sound-generating unit 100. It can be understood that ventilation and isolation can be achieved by using the breathable spacer 4. That is, the breathable spacer 4 does not affect the airflow, but can play a role in waterproof and dustproof. In an embodiment, the breathable spacer 4 can be an isolation net, a mesh, a metal mesh cover or a damping piece, and the like, which is not limited here.

In an embodiment, the housing 1 is provided with a bottom plate 11, an inside plate 12 and an outside plate 13. The inside plate 12 is connected to the edge magnetic conductive piece 25, the outside plate 13 is connected to the bass outer folding ring 313, and the bottom plate 11 is provided with a bass sound outlet 111.

In this embodiment, as shown in FIG. 1 to FIG. 9, by making the housing 1 composed by a bottom plate 11, an inside plate 12 and an outside plate 13, the inside plate 12 and the outside plate 13 are provided at both sides of the bottom plate 11, and are provided at an angle with the bottom plate 11. In this case, the bottom plate 11, the inside plate 12 and the outside plate 13 are enclosed to form a concave structure, and the edge of the bass vibration diaphragm 311 is conveniently connected to the outside plate 13 of the housing 1, thereby providing the avoidance and vibration space for the vibration process of the bass vibration diaphragm 311 by using the concave structure.

It can be understood that the outside edge of the bass outer folding ring 313 of the bass vibration diaphragm 311 is connected to the outside plate 13 of the housing 1. The outside plate 13 may be provided with a connection platform and other structures, so that the bass outer folding ring 313 can be connected to the outside plate 13 through the connection platform. The inside plate 12 of the housing 1 is in the annular shape, forming an annular inner cavity, so as to facilitate installing the magnetic circuit system 2, the midrange vibration unit 32 and the treble vibration unit 33. In an embodiment, the inside plate 12 of the housing 1 is connected to the edge magnetic conductive piece 25 of the magnetic circuit system 2.

In an embodiment, the housing 1 is a metal portion, so that the magnetic circuit system 2 and the vibration system 3 can be installed and fixed inside the housing 1, and the housing 1 can be used to achieve heat dissipation. Of course, the housing 1 can further be an injection molded portion. Or, the housing 1 is a structure formed by the injection molded portion integrated with the metal portion, which is not limited here.

In this embodiment, a bass sound outlet 111 is provided at the bottom plate 11 of the housing 1, so that the bass sound outlet 111 can smoothly conduct the sound of the bass vibration unit 31. In an embodiment, the midrange vibration unit 32, the treble vibration unit 33 and the bass sound outlet 111 are provided at the same side of the sound-generating unit 100, so that the bass unit, the midrange unit and the treble unit of the sound-generating unit 100 can be sound from the same side.

The present application further proposes an electronic device, which includes the above-mentioned sound-generating unit 100. The specific structure of the sound-generating unit 100 may refer to the above-mentioned embodiments. Since the electronic device adopts all the technical solutions of all the above-mentioned embodiments, it has at least all the beneficial effects brought by the technical solutions of the above-mentioned embodiments, which will not be repeated here.

The above are only some embodiments of the present application, and do not limit the scope of the present application thereto. Under the concept of the present application, any equivalent structural transformation made according to the description and drawings of the present application, or direct/indirect applied in other related technical fields shall fall within the protection scope of the present application.

What is claimed is:

1. A sound-generating unit, comprising:
a housing, wherein a conductive terminal is formed at the housing by injection molding;
a magnetic circuit system, wherein the magnetic circuit system is provided in the housing, and the magnetic circuit system is provided with a bass magnetic gap and a midrange magnetic gap; and
a vibration system comprising a bass vibration unit, a midrange vibration unit and a treble vibration unit;
wherein the midrange vibration unit and the treble vibration unit are provided at a same side of the magnetic circuit system, and the midrange vibration unit is provided around the treble vibration unit;
the bass vibration unit is provided at the other side of the magnetic circuit system;
the bass vibration unit comprises a bass vibration diaphragm and a bass voice coil, and the bass voice coil is provided in the bass magnetic gap;
the midrange vibration unit comprises a midrange vibration diaphragm and a midrange voice coil, and the midrange voice coil is provided in the midrange magnetic gap; and
the treble vibration unit is a piezoelectric unit.

2. The sound-generating unit according to claim 1, wherein:
the magnetic circuit system comprises a first magnetic conductive piece, a center magnet, an edge magnet, a center magnetic conductive piece and an edge magnetic conductive piece;
the center magnet and the edge magnet are provided at the first magnetic conductive piece;
the center magnetic conductive piece is provided at a side of the center magnet away from the first magnetic conductive piece, and the edge magnetic conductive piece is provided at a side of the edge magnet away from the first magnetic conductive piece;
the edge magnetic conductive piece is provided with a sidewall; and
the bass magnetic gap is formed between the sidewall and the first magnetic conductive piece, and the midrange magnetic gap is formed between the center magnetic conductive piece and the edge magnetic conductive piece.

3. The sound-generating unit according to claim 2, wherein the bass vibration diaphragm comprises a bass inner folding ring, a bass outer folding ring and a bass vibration plate; and
the bass inner folding ring is connected to the magnetic circuit system, and the bass outer folding ring is connected to the housing.

4. The sound-generating unit according to claim 3, wherein a support block is provided at a side of the magnetic circuit system close to the bass vibration unit, and the bass inner folding ring is fixed to the support block.

5. The sound-generating unit according to claim 4, wherein:
the support block is made of magnetic material, and a magnetization direction of the support block is opposite to a magnetization direction of the center magnet; or
the support block is made of non-magnetic material.

6. The sound-generating unit according to claim 2, wherein the midrange vibration diaphragm comprises a midrange inner folding ring, a midrange outer folding ring and a midrange vibration plate; and
the midrange inner folding ring is connected to the center magnetic conductive piece, and the midrange outer folding ring is connected to the edge magnetic conductive piece.

7. The sound-generating unit according to claim 6, wherein:
the edge magnetic conductive piece is provided with an outer bracket, and the midrange outer folding ring is fixed to the outer bracket; and
the center magnetic conductive piece is provided with an inner bracket, and the midrange inner folding ring is fixed to the inner bracket.

8. The sound-generating unit according to claim 7, wherein the treble vibration unit comprises a treble vibration plate and a piezoelectric ceramic provided at the treble vibration plate, and an edge of the treble vibration plate is fixed to the inner bracket.

9. The sound-generating unit according to claim 8, wherein the inner bracket is provided with a substrate and a surrounding plate provided around a periphery of the substrate; and
the treble vibration plate is connected to the surrounding plate, and a treble back cavity is formed between the treble vibration unit and the inner bracket.

10. The sound-generating unit according to claim 7, wherein:
the magnetic circuit system is provided with a through hole, and the through hole communicates the midrange magnetic gap with an external space of the sound-generating unit;
the through hole comprises a first through hole penetrating the first magnetic conductive piece, a second through hole penetrating the center magnet, and a third through hole penetrating the center magnetic conductive piece; and
the first through hole, the second through hole and the third through hole are communicated with each other.

11. The sound-generating unit according to claim 3, wherein the housing is provided with a bottom plate, an inside plate and an outside plate;
the inside plate is connected to the edge magnetic conductive piece, and the outside plate is connected to the bass outer folding ring; and
the bottom plate is provided with a bass sound outlet.

12. An electronic device, comprising the sound-generating unit according to claim 1.
